(19) United States
(12) Patent Application Publication
(10) Pub. No.: US 2026/0079112 A1
(43) Pub. Date: Mar. 19, 2026

(54) MICRO-RAMAN SPECTROMETER AND SPECTROSCOPIC MEASUREMENT METHOD

(71) Applicant: Kioxia Corporation, Tokyo (JP)

(72) Inventor: Yuki WAKISAKA, Yokkaichi (JP)

(73) Assignee: Kioxia Corporation, Tokyo (JP)

(21) Appl. No.: 19/079,011

(22) Filed: Mar. 13, 2025

(30) Foreign Application Priority Data
Sep. 17, 2024 (JP) 2024-160394

(51) Int. Cl. G01N 21/65; G01N 21/64

(52) U.S. Cl. CPC G01N 21/65; G01N 21/6402; G01N 2201/06113

(57) ABSTRACT

According to some embodiments, a micro-Raman spectrometer includes a stage configured to hold a sample on a surface of which a fluorescent material is applied. The micro-Raman spectrometer includes a laser optical system configured to irradiate the sample with laser light. The micro-Raman spectrometer includes a Raman scattered light detector configured to detect Raman scattered light emitted from the sample. The micro-Raman spectrometer includes a fluorescence detector configured to detect fluorescence emitted from the fluorescent material. The micro-Raman spectrometer includes an analyzer configured to analyze a Raman signal of the Raman scattered light detector and a fluorescence signal of the fluorescence detector. The micro-Raman spectrometer includes a controller connected to the analyzer and configured to control the stage and the laser optical system.

### CROSS-REFERENCE TO RELATED APPLICATION

This application is based upon and claims the benefit of priority from Japanese Patent Application No. 2024-160394, filed Sep. 17, 2024, the entire contents of which are incorporated herein by reference.

### FIELD

Embodiments described herein relate generally to a micro-Raman spectrometer, a micro-Raman measurement method, and a program.

### BACKGROUND

In micro-Raman spectroscopy, mapping can be performed by narrowing the spot diameter of an excitation laser on a sample and scanning the sample and/or the laser. In this case, in order to align the focus of the laser light with the sample, the distance between the sample and an objective lens is swept and adjusted to maximize the Raman scattering intensity or Rayleigh scattering intensity of a target material or to optimize the optical microscopic image of the sample surface.

Examples of related art include JP-A-2015-49241, JP-A-10-90064, and JP-A-2008-116432.

### DESCRIPTION OF THE DRAWINGS

FIG. 1 is a block diagram of a micro-Raman spectrometer according to an embodiment.

FIG. 2 is a flowchart of a micro-Raman measurement method of the micro-Raman spectrometer according to the embodiment.

FIG. 3A is a configuration diagram of a micro-Raman spectrometer according to a comparative example.

FIG. 3B is a schematic diagram of a micro-Raman spectroscopy result of a carbon surface in FIG. 3A.

FIG. 3C is a schematic diagram of a micro-Raman spectroscopy result of a silicon surface in FIG. 3A.

FIG. 4 is a configuration diagram of the micro-Raman spectrometer according to the embodiment.

FIG. 5 is a configuration diagram of a laser optical system of the micro-Raman spectrometer according to the embodiment.

FIG. 6A is a cross-sectional view of a sample having a fluorescent material formed on the surface.

FIG. 6B is a cross-sectional view of a sample having one type of fluorescent material formed on the surface.

FIG. 6C is a cross-sectional view of a sample having two types of fluorescent material formed on the surface.

FIG. 7A is an explanatory view of an absorption spectrum and a fluorescence spectrum of a selected ZnSe nanoparticle fluorescent material, a Raman excitation wavelength (Raman excitation wavelength: 355 nm), and a wavelength characteristic of a Raman shift.

FIG. 7B is an explanatory view of an absorption spectrum and a fluorescence spectrum of a selected ZnSe nanoparticle fluorescent material, a Raman excitation wavelength (Raman excitation wavelength: 485 nm), and a wavelength characteristic of a Raman shift.

### DETAILED DESCRIPTION

When taking a mapping measurement on a region across materials different having compositions and optical characteristics, the focus of the laser spot cannot be aligned with the sample surface in order to maximize the Raman scattering intensity and the Rayleigh scattering intensity of a target. Alternatively, it is necessary to grasp the optical characteristics of each of the constituent materials in advance, which is difficult. When capturing an optical microscopic image of the sample surface, when flatness of a device structure and the like is not guaranteed, there is no guarantee that the distance between the sample and the objective lens is optimized in the region that is actually irradiated with laser.

Embodiments provide a micro-Raman spectrometer, a micro-Raman measurement method, and a program (non-transitory computer-readable storage media having instructions stored thereon that, when executed by at least one processor, cause the at least one processor to perform operations) in which high spatial resolution is stably obtained even when taking a mapping measurement across materials having different compositions and physical properties in micro-Raman spectroscopy.

In general, according to one embodiment, a micro-Raman spectrometer includes a stage configured to hold a sample on a surface of which a fluorescent material is applied, a laser optical system configured to irradiate the sample with laser light, a Raman scattered light detector configured to detect Raman scattered light emitted from the sample, a fluorescence detector configured to detect fluorescence emitted from the fluorescent material, an analyzer configured to analyze a Raman signal of the Raman scattered light detector and a fluorescence signal of the fluorescence detector, and a controller connected to the analyzer and configured to control the stage and the laser optical system. The controller adjusts a Z position for irradiating an XY plane of the sample with the laser light in a Z direction perpendicular to the XY plane at a certain XY position on the XY plane based on a detection result of the fluorescence detector, and performs detection by the Raman scattered light detector at the Z position. For example, the sample can be held on a stage, where a fluorescent material applied to a surface of the sample is excitable by a wavelength of the Raman measurement laser light. In this example, the stage can be configured to hold a sample including a fluorescent material applied to a surface.

Hereinafter, embodiments will be described with reference to drawings. In the following description, the same reference numerals are given to the same or similar members, and the description of members that have already been described will be omitted as appropriate. In the following description, a surface of a sample is referred to as an XY plane, a direction perpendicular to the XY plane is referred to as a Z direction, a first direction of the sample surface is referred to as an X direction, and a second direction perpendicular to the first direction is referred to as a Y direction.

Hereinafter, embodiments will be described with reference to drawings.

### Configuration of Micro-Raman Spectrometer

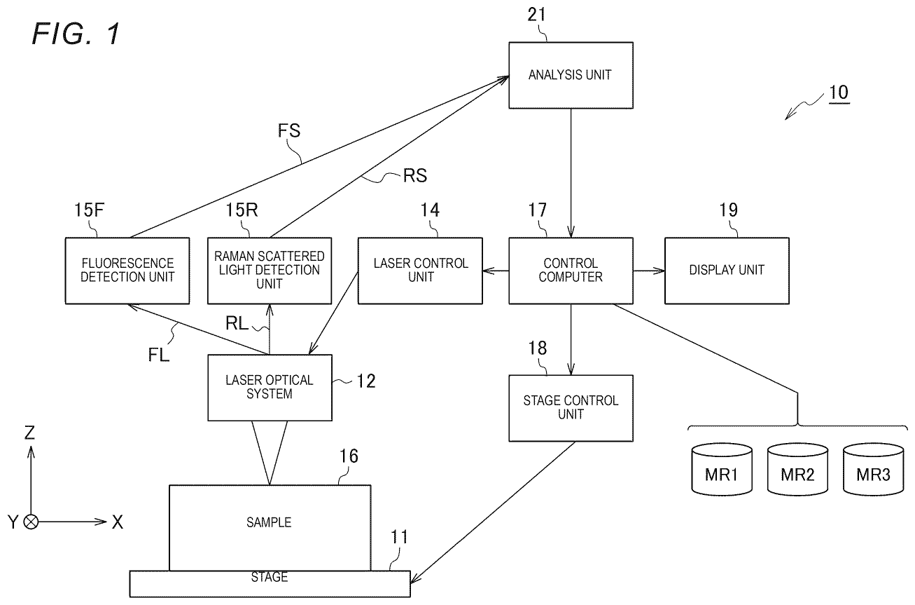

FIG. 1 is a block diagram of a micro-Raman spectrometer 10 according to an embodiment.

The micro-Raman spectrometer 10 according to the embodiment includes a stage 11, a laser optical system 12, a Raman scattered light detector 15R (e.g., Raman scattered light detection unit), a fluorescence detector 15F (e.g., fluorescence detection unit), an analyzer 21 (e.g., analysis unit and/or analysis system), and a controller 17 (e.g., control computer). Additionally, it should be understood that while a Raman scattered light detector 15R is described herein, other scatter light detectors (e.g., Rayleigh scattered light detectors, Brillouin scattered light detectors, elastic scattered light detectors, and inelastic scattered light detectors) can be used and/or implemented to perform the operations and analyze additional optical properties of the sample, such as refractive index variations or molecular interactions. It should be understood that the various systems and devices described herein (e.g., controller 17, analyzer 21, stage controller 18, laser controller 14, memory units MR1, MR2, MR3, fluorescence detector 15F, Raman scattered light detector 15R, ashing mechanism, display unit 19, laser optical system 12, attenuating filter 13D, fluorescence filter FF, removal filter RF, laser light source 12S, and/or any associated signal processing units) can be implemented, in part or in whole, using one or more processing circuits. Such processing circuits can include a microprocessor, digital signal processor (DSP), application-specific integrated circuit (ASIC), field-programmable gate array (FPGA), and/or other programmable logic devices configured to execute control operations, process detected signals, store and retrieve measurement data, and coordinate system functionality. The processing circuit can execute instructions stored in non-transitory memory to manage adjustments, perform spectral analysis, compare detected signals with reference data, and/or facilitate user interaction through a graphical interface or external communication interface.

The stage 11 holds (e.g., stores, maintains, supports, secures, stabilizes, and/or any structure for positioning a sample) a sample 16 on a surface of which (e.g., to which, coated in) a fluorescent material is applied. For example, the sample can be held on a stage, where a fluorescent material applied to a surface of the sample is excitable by a wavelength of the Raman measurement laser light. In this example, the stage can be configured to hold a sample including a fluorescent material applied to a surface. That is, the stage 11 can hold a sample 16 including a fluorescent material applied on a surface (e.g., the surface can be coated with a fluorescent material). The laser optical system 12 can irradiate the sample 16 with laser light (e.g., direct laser light onto the sample 16, expose the sample 16 to laser light, project laser light onto the sample 16, etc.). The Raman scattered light detector 15R detects Raman scattered light RL (e.g., scattered photons with a frequency shift indicative of molecular vibrations, material composition, and/or structural properties) emitted from the sample 16. The fluorescence detector 15F detects fluorescence FL (e.g., emitted photons resulting from electronic transitions in the fluorescent material, used for depth profiling and/or surface characterization) emitted from a fluorescent material 140. The analyzer 21 receives a Raman signal RS of the Raman scattered light detector 15R and a fluorescence signal FS of the fluorescence detector 15F.

The controller 17 is connected to the analyzer 21 and controls the stage 11 and the laser optical system 12. The controller 17 adjusts a Z position for irradiating an XY plane of the sample 16 with the laser light in a Z direction perpendicular to the XY plane at a certain XY position on the XY plane based on a detection result of the fluorescence detector 15F, and performs detection (e.g., acquiring Raman spectral data, capturing scattered light intensity, processing wavelength shifts, and/or analyzing molecular composition) by the Raman scattered light detector 15R at the Z position.

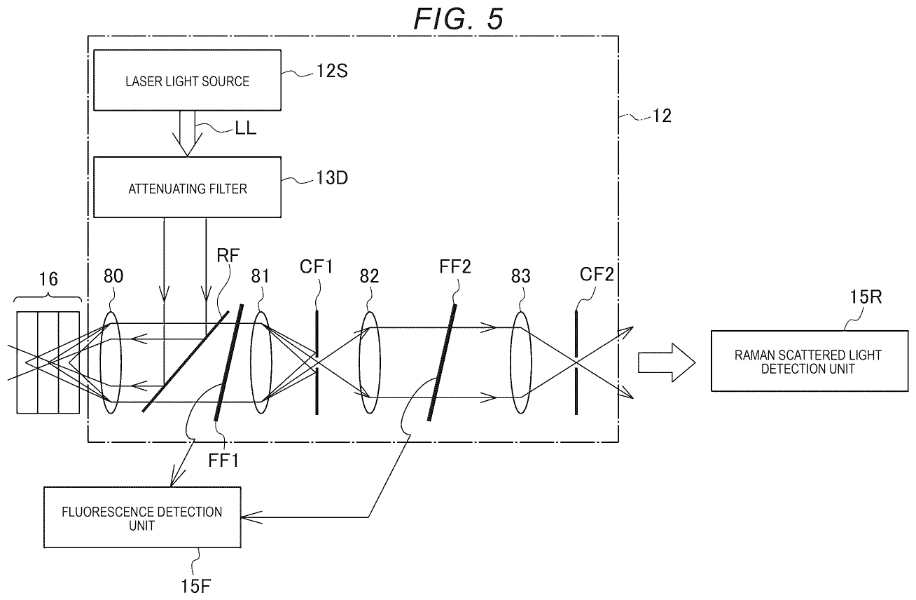

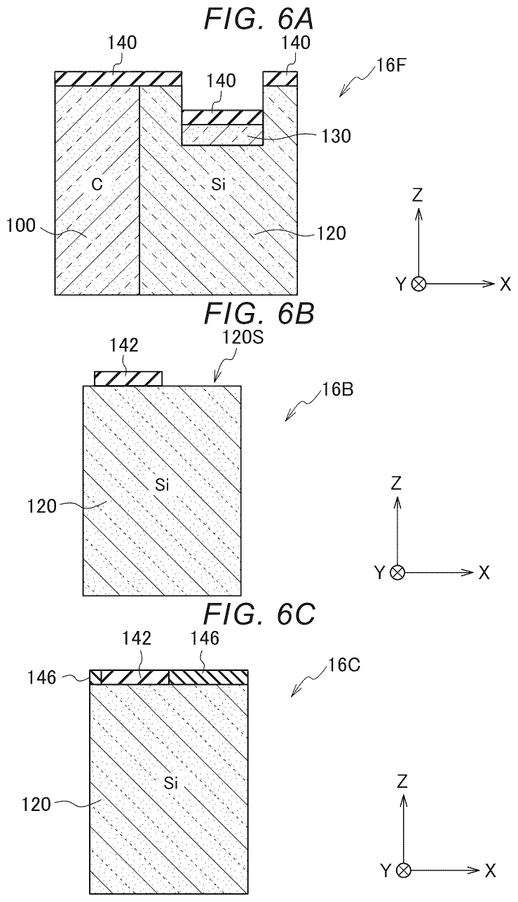

The sample 16, on a surface of which the fluorescent material 140 is applied, is placed on the stage 11. The structural example of the sample 16 will be described with reference to FIGS. 6A to 6C.

The laser optical system 12 is a laser light irradiation unit capable of irradiating the stage 11 with Raman measurement laser light. The laser optical system 12 will be described with reference to FIG. 5.

The analyzer 21 receives the Raman signal RS of the Raman scattered light detector 15R and the fluorescence signal FS of the fluorescence detector 15F. In the micro-Raman spectrometer 10 according to the embodiment, it is only necessary to detect the peak level of the fluorescence signal FS of the fluorescence detector 15F. Therefore, the fluorescence signal FS of the fluorescence detector 15F may be directly input to the controller 17.

The adjustment of the Z position for irradiating with the laser light is performed by controlling the laser optical system 12 and/or the stage 11.

The micro-Raman spectrometer 10 according to the embodiment further includes a laser controller 14, a display unit 19, a stage controller 18, a first memory MR1, a second memory MR2, and a third memory MR3.

The laser controller 14 is controlled by the controller 17. The laser controller 14 controls the laser optical system 12 to adjust the wavelength and intensity of the Raman measurement laser light and the XYZ position of the laser light irradiation.

The display unit 19 is connected to the controller 17 and displays a Raman spectrum of the Raman scattered light RL, a fluorescence spectrum of the fluorescence FL, an optical microscopic image and an analysis result of the sample surface, and a mapping measurement result of micro-Raman spectroscopy.

The stage controller 18 is controlled by the controller 17. The stage controller 18 adjusts the XYZ position of the stage.

The first memory MR1 is connected to the controller 17 and stores reference data required for the component analysis of the sample 16.

The second memory MR2 is connected to the controller 17 and stores the analysis result.

The third memory MR3 is connected to the controller 17 and stores an XY pattern and XYZ mapping (map) information based on z information. That is, the third memory MR3 stores a combination (e.g., correspondence data, calibration parameters, spatial alignment references, and/or measurement coordinates) of the XY position and the Z position. The combination can be a data set associating each XY coordinate with a corresponding Z position, a matrix mapping spatial locations to height values, a structured table of positional relationships, and/or a layered representation of surface depth variations.

The analyzer 21 also performs general spectrum processing such as background removal mixed in the Raman scattered light spectrum. In addition, since the fluorescence-derived fluorescence spectrum may remain, difference processing with the fluorescence spectrum from the fluorescence detector 15F is also performed. Thereafter, the component analysis is performed by referring to the first memory MR1 for the component analysis of the sample 16. The Raman scattered light detector 15R and the fluorescence detector 15F may also execute general spectrum processing such as background removal.

### Operation of Micro-Raman Spectrometer

The stage 11 holds and moves the sample 16 in the horizontal direction (XY direction) according to a control signal sent from the stage controller 18 via an actuator (not shown) so that the laser light is incident on a target position on the surface of the sample 16. The stage controller 18 generates a control signal for moving the stage 11 based on a signal from the controller 17 (e.g., the controller 17 is configured to control the stage 11 by adjusting step increments, modifying scanning speed, applying real-time corrections, and/or synchronizing movement with data acquisition).

The fluorescence detector 15F detects the fluorescence FL obtained from the sample 16 by irradiation with laser light, outputs the fluorescence signal FS, and sends the fluorescence signal FS to the analyzer 21. The fluorescence detector 15F is a detector capable of detecting a wavelength range of fluorescence spectrum. The XYZ mapping information of the analysis target position in the sample 16 can be obtained from the fluorescence signal FS. When the surface of the sample 16 has a step shape, the step information (Z information) is also contained in the mapping information of the sample surface.

The laser controller 14 generates a control signal based on wavelength information given from the controller 17 and sends the control signal to the laser optical system 12. The laser optical system 12 is provided with a plurality of laser light sources that emit laser light having a given wavelength, and selects a laser light source in accordance with a control signal sent from the laser controller 14 to irradiate the sample 16 with the laser light.

The Raman scattered light detector 15R detects the Raman scattered light RL obtained from the sample 16 by irradiation with laser light, outputs the Raman signal RS, and sends the Raman signal RS to the analyzer 21. The analyzer 21 calculates a Raman spectrum from the Raman signal RS sent from the Raman scattered light detector 15R and sends the Raman spectrum to the controller 17.

The analyzer 21 analyzes (e.g., identifies molecular structures, detects chemical compositions, determines material properties, extracts spectral features, and/or compares spectral data against reference databases) the component of the material at the analysis target position by analyzing the Raman spectrum. That is, analyzing can include spectral deconvolution, peak identification, intensity normalization, baseline correction, noise filtering, and/or correlation with predefined spectral models

In addition, the analyzer 21 measures the mapping information of the analysis target position of the sample 16 based on the measurement result from the fluorescence detector 15F, and sends the measurement result to the controller 17. The controller 17 saves the mapping information of the sample surface in the third memory MR3.

The controller 17 is connected to (e.g., communicably coupled, such as by wired interfaces, wireless protocols, network connections, etc.) the laser controller 14 and the stage controller 18, and generates various control signals and sends the control signals to these units. The controller 17 is also connected to the first memory MR1. The first memory MR1 stores a reference spectrum obtained in advance for a plurality of types of component distributions, and the controller 17 reads the reference spectrum from the first memory MR1 and executes component analysis.

In the operation of the micro-Raman spectrometer 10 according to the embodiment, since the fluorescent material 140 is applied on the sample surface, the laser light is one type, and the signal corresponding to the fluorescence information obtained by scanning the stage 11 can be mapped. Since the fluorescent material is applied on the sample surface (e.g., fluorescent material applied on a surface, the surface can be coated with a fluorescent material), it is not necessary to irradiate the sample having a step shape with laser light having different wavelengths.

In the operation of the micro-Raman spectrometer 10 according to the embodiment, high spatial resolution can be stably achieved regardless of the surface shape of the sample. The sample can also be used in a device system having an interface between different limited to a semiconductor. Since the Z measurement uses the fluorescence intensity instead of the Raman scattered light, the Z information can be acquired in a short time.

In addition, once the sample surface shape can be acquired by the fluorescence intensity acquired, the information is saved, and it is possible to take a Raman measurement on a similar sample without pre-processing such as applying a fluorescent material. In the case of a large number of the same or similar samples, when the surface shape of only one sample can be acquired by the fluorescence intensity, the information is saved, and the other samples can be measured by Raman measurement without pre-processing. In addition, pre-processing such as applying a fluorescent material is required for measuring the foreign matter on the sample surface.

### Micro-Raman Measurement Method

In a micro-Raman measurement method of the micro-Raman spectrometer 10 according to the embodiment, the sample 16, on a surface of which the fluorescent material 140 to be excited by the wavelength of Raman measurement laser light is applied, is held on the stage 11.

Next, the surface of the sample 16 is irradiated with Raman measurement laser light, and the intensity of the fluorescence FL from the fluorescent material 140 is detected by the fluorescence detector 15F.

Next, based on the detection result of the fluorescence detector 15F, the controller 17 measures an optimum Z position for irradiating the XY plane of the sample 16 with the laser light in the Z direction perpendicular to the XY plane at a certain XY position on the XY plane. The information (XYZ) on the surface shape of the sample, which is stored in advance in the third memory MR3, may be referred to.

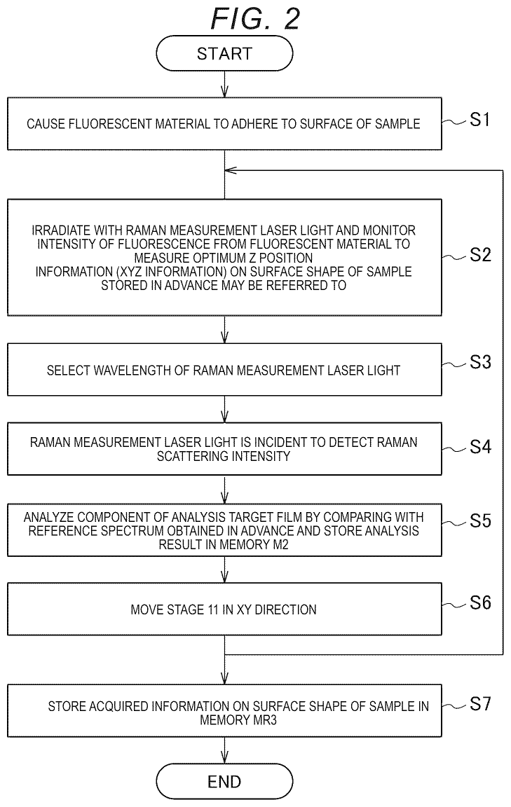

Next, a wavelength of the Raman measurement laser light is selected. Here, the reason for selecting the wavelength of the Raman measurement laser light will be described with reference to the flowchart of FIG. 2.

Next, the selected Raman measurement laser light is incident on the surface of the sample 16, and the intensity of the Raman scattered light RL is detected by the Raman scattered light detector 15R.

Next, in the analyzer 21, the component of an analysis target film is analyzed by comparing the plurality of types of component distributions with the reference spectrum saved in the first memory MR1, and the analysis result is saved in the second memory MR2.

Next, the stage 11 is moved in the XY direction, the optimum Z position at a different XY position is measured, another analysis (e.g., second analysis) result by the analyzer 21 is saved in the second memory MR2, and information on the surface shape of the sample is acquired.

Next, the acquired information on the surface shape of the sample is stored in the third memory MR3.

### Flowchart

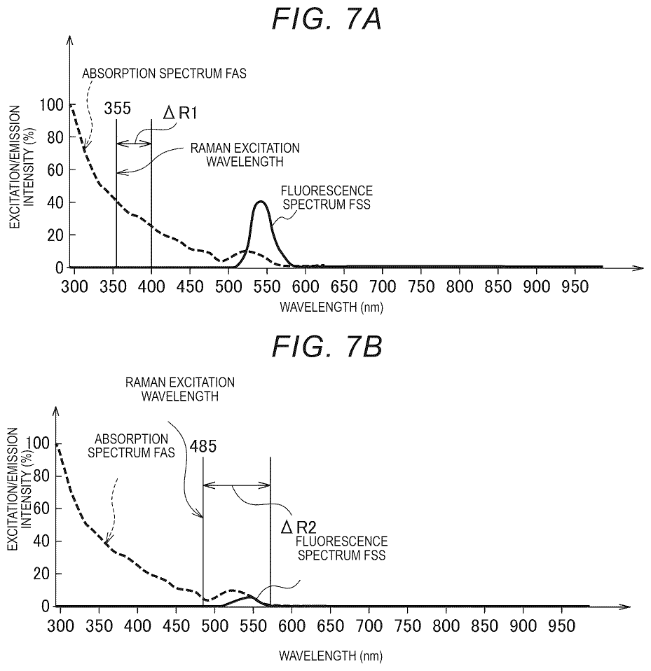

FIG. 2 is a flowchart of a micro-Raman measurement method. The method will be described in detail below.
(A) First, in step S1, the fluorescent material 140 to be excited by the wavelength of the Raman measurement laser light adheres to the surface of the sample 16. For example, a nanoparticle material or an organic molecule material can be applied as the fluorescent material 140. The fluorescent material 140 will be described later. After step S1 and before the transition to step S2, there is a step of selecting Raman measurement laser light, although the description is omitted.
(B) Next, in step S2, the surface of the sample 16 is irradiated with Raman measurement laser light, and the intensity of the fluorescence FL from the fluorescent material 140 is detected by the fluorescence detector 15F. By monitoring the intensity of the fluorescence FL from the fluorescent material 140, the optimum Z position can be measured. In step S2, the information on the surface shape of the sample (XYX information), which is stored in advance in the memory M3, may be referred to. In addition, prior information such as design information and layout information of the sample may be referred to. As a result, an initial value on the XY plane can be efficiently set.
(C) Next, in step S3, a wavelength of the Raman measurement laser light is selected. The laser optical system 12 is provided with a plurality of laser light sources 12S (see FIG. 5) that emit Raman measurement laser light based on the wavelength information given from the controller 17. The laser light source 12S can be selected and the Raman measurement laser light can be radiated on the sample 16 according to a control signal sent from the laser controller 14. Here, in step S3, the selectin of the wavelength of the Raman measurement laser light is based on the assumption that the Raman excitation wavelength is changed (FIG. 7). For example, in step S2, the laser wavelength that can excite only the fluorescent material 140 is selected, and then, in step S3, the laser wavelength that cannot excite the fluorescent material 140 is selected so that the Raman measurement can be taken without generating fluorescence (without considering fluorescence interference). However, time loss occurs due to switching of the laser light, and it may take a considerable time to switch the laser light at each XY point, and in this case, it is possible to cope with the case by not taking the Raman measurement after step S2, and once sweeping all the XY points and then moving to the Raman measurement. In this case, the laser switching is performed only once. When it is not necessary to change the Raman excitation wavelength, step S3 may be omitted.
(D) Next, in step S4, the surface of the sample 16 is irradiated with Raman measurement laser light, and the intensity of the Raman scattered light RL is detected by the Raman scattered light detector 15R. Here, since the Raman measurement is taken in a wavelength range that is not affected by the fluorescence spectrum, the measurement can be taken while the fluorescent material 140 adheres.
(E) Next, in step S5, in the analyzer 21, the component of the analysis target film is analyzed by comparing the plurality of types of component distributions with the reference spectrum obtained in advance, and the analysis result is saved in the second memory MR2. The reference spectrum is saved in the first memory MR1.
(F) Next, in step S6, the stage 11 is moved in the XY direction.
(G) Next, the process returns to step S2, and the optimum Z position is measured at a different XY position. Step S3, step S4, step S5, and step S6 are executed, and the analysis result of the component of the analysis target film is saved in the second memory MR2, and information on the sample surface shape is acquired.
(H) Next, in step S7, the acquired information on the sample surface shape is stored in the third memory MR3. In the final map creation, all the XY operations are executed, and the acquired information on the sample surface shape at each point is saved in the third memory MR3.

In the micro-Raman spectrometer 10 according to the embodiment, the optimum Z position is adjusted based on the acquired information on the sample surface shape.

### Field of View Range and Measurement Time of Sample Surface

In the micro-Raman spectrometer 10 according to the embodiment, when the stage 11 is moved in the XY direction, the field of view of the sample surface is, for example, about 500 nm square to several tens of μm square. A step of moving the stage 11 in the XY direction is, for example, about several tens of nm to 1 μm. When measuring a 10 μm square sample in 1 μm steps, measurements must be taken at 10×10=100 points. The measurement time per point is determined by the SN ratio and the intensity of the Raman scattered light. If the measurement time per point is 1 minute, the measurement time for a 10 μm square sample will be 100 minutes, and if the measurement time per point is 3 minutes, the measurement time will be 300 minutes=5 hours. When a 10 μm square sample is measured in 500 nm steps, the measurement time is four times as long as this value, or 20 hours. The numerical values of the field of view range and the measurement time of the sample surface are examples and are not limited thereto.

### Removal Processing of Fluorescent Material

In the micro-Raman measurement method of the micro-Raman spectrometer 10 according to the embodiment, the optimum Z position for measuring the Raman scattering intensity is determined by applying a fluorescent material to the sample surface. Thereafter, it is not necessary to remove the applied fluorescent material even when measuring the Raman scattering intensity. On the other hand, for example, when assuming a large-diameter silicon wafer, and applying this method to in-line measurements, it is necessary to remove the fluorescent material in order to realize non-destructive measurement. In order to remove the fluorescent material, a solvent that chemically reacts with the fluorescent material can be applied by spin coating to remove the fluorescent material by chemical treatment.

In addition, when the fluorescent material is an organic fluorescent material, an ashing mechanism capable of removing the organic fluorescent material may be included. Here, the ashing mechanism is a heat treatment apparatus for performing ashing treatment by heating an organic fluorescent material. When the fluorescent material is an organic material, the fluorescent material can be removed by ashing the fluorescent material by using an ashing mechanism (e.g., thermal decomposition, oxidation, plasma treatment, and/or chemical vaporization). The ashing mechanism can be a plasma asher, a resist stripper, an oxidation furnace, and/or any high-temperature processing system that facilitates removal of organic residues through controlled heating, oxidation, and/or plasma exposure. In this case, the organic fluorescent material is removed in the entire region. As the heat treatment apparatus, a laser annealing treatment apparatus or a lamp annealing treatment apparatus may be used.

### Micro-Raman Spectrometer: Comparative Example

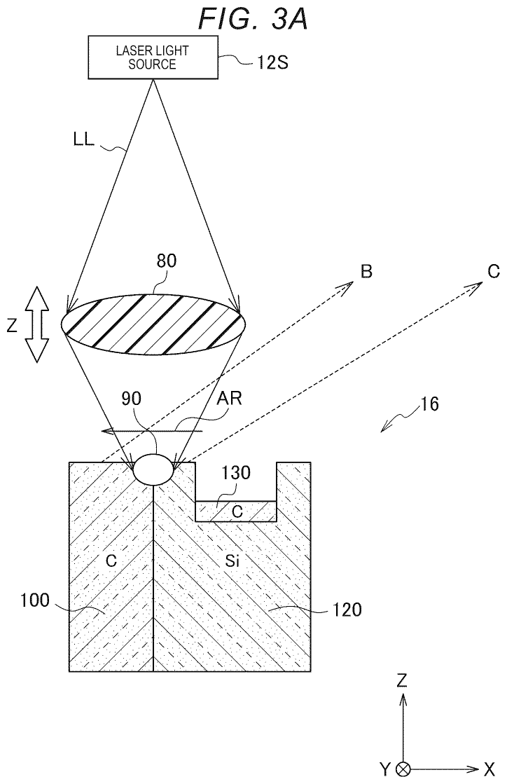

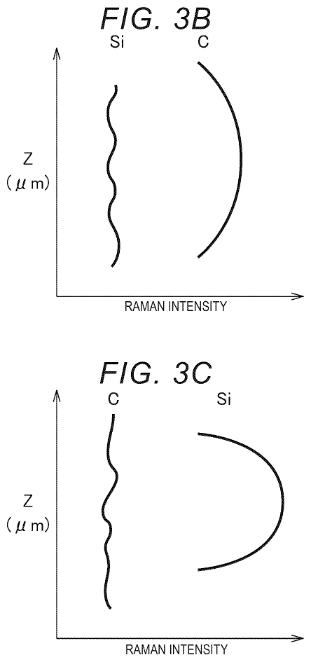

FIG. 3A is a schematic configuration diagram of a micro-Raman spectrometer according to a comparative example. Laser light LL incident from the laser light source is radiated on the surface of a sample 16F via a lens 80. An irradiation spot 90 moves in the XY direction by moving the stage 11. The lens 80 moves in the Z direction. The sample 16F has, for example, a combined structure of a carbon (C) region 100 and a silicon (Si) region 120, a step is provided in the silicon region 120, and another carbon region 130 is provided on the bottom surface of the step. The sample 16F will be described in detail with reference to FIG. 6A together with the description of the material of the fluorescent material 140.

In FIG. 3A, the broken line B shows an example of Raman scattered light when the irradiation spot 90 is only in the carbon region 100, and the broken line C shows an example of Raman scattered light when the irradiation spot 90 is only in the silicon region 120.

FIG. 3B is a schematic diagram of the micro-Raman spectroscopy result of the carbon region 100 in FIG. 3A. In FIG. 3B, the intensity of carbon is observed, and the intensity of silicon is a noise level.

FIG. 3C is a schematic diagram of the micro-Raman spectroscopy result of the silicon region 120 in FIG. 3A. In FIG. 3C, the intensity of silicon is observed, and the intensity of carbon is a noise level and is not observed.

In addition, when a height Z is optimized by the Raman intensity of silicon when the irradiation spot 90 is mainly in the carbon region 100 and slightly in the silicon region 120, since the Raman intensity of silicon is increased more when the irradiation region of the irradiation spot 90 is somewhat larger than when the irradiation region is the minimum, a non-optimum height Z is erroneously determined to be optimal. From the above, it is necessary to optimize the height Z with the Raman intensity from a material in the region where the irradiation spot 90 is mainly irradiated, that is, with the Raman intensity from carbon in the carbon region 100, and with the Raman intensity from silicon in the silicon region 120, but since the boundary between the carbon region 100 and the silicon region 120 is unknown in the actual Raman spectral measurement, as indicated by the arrow AR in FIG. 3A, when irradiation spot 90 is present across the silicon region 120 and the carbon region 100 in the Raman spectral measurement, it is not possible to determine how far the height Z should be optimized with the Raman intensity of silicon and how far the height Z should be optimized with the Raman intensity of carbon in the region. If the carbon region 100 and the silicon region 120 are at the same height, both regions can be distinguished from the Raman intensity signals, but when the irradiation spot 90 is fitted into the valley of the carbon (C) region 130 in the Raman spectral measurement, the difference in the material and/or the difference in the focus of the silicon region 120 cannot be distinguished.

In the micro-Raman spectrometer according to the comparative example, it is difficult to observe the carbon region 130 at the step bottom. In the micro-Raman spectrometer according to the comparative example, it is difficult to use the micro-Raman spectrometer in a region where the surface is not flat.

### Micro-Raman Spectrometer: Embodiment

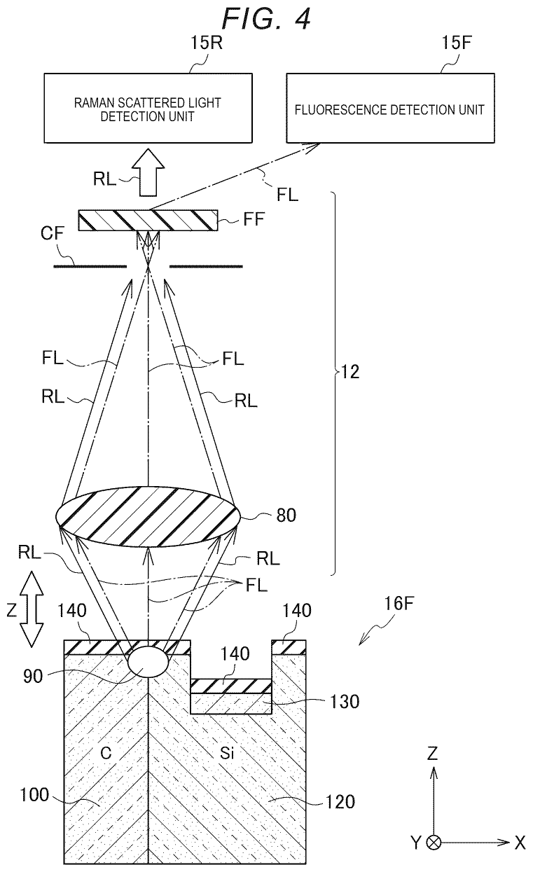

FIG. 4 is a configuration diagram of the micro-Raman spectrometer 10 according to the embodiment. FIG. 4 shows the laser optical system 12, the sample 16F, the Raman scattered light detector 15R, and the fluorescence detector 15F for convenience of description. The laser light source is not shown.

The laser light incident from the laser light source is radiated on the surface of the sample 16 via the lens 80. The irradiation spot 90 moves in the XY direction by moving the stage 11. The lens 80 moves in the Z direction. The sample 16 has, for example, a combined structure of the carbon region 100 and the silicon region 120, a step is provided in the silicon region 120, and for example, another carbon region 130 is provided on the bottom surface of the step. The description so far is the same as in FIG. 3A.

In the sample 16F shown in FIG. 4, the fluorescent material 140 to be excited by the wavelength of the Raman measurement laser adheres to the sample surface.

As shown in FIG. 4, the light emitted from the irradiation spot 90 includes the Raman scattered light RL and the fluorescence FL. The Raman scattered light RL and the fluorescence FL are condensed on a slit CF via the lens 80. The Raman scattered light RL and the fluorescence FL that have passed through the hole of the slit CF are spectrally separated by a fluorescence filter FF. The Raman scattered light RL that is spectrally separated by the fluorescence filter FF is incident on the Raman scattered light detector 15R. The fluorescence FL that is spectrally separated by the fluorescence filter FF is incident on the fluorescence detector 15F. For example, a dichroic mirror or the like may be used for the fluorescence filter FF.

In the micro-Raman spectrometer according to the embodiment, the fluorescent material 140 can adhere to the sample surface, and the optimum Z position can be determined by monitoring the intensity of the fluorescence FL. Therefore, the micro-Raman spectrometer according to the embodiment can be used in a region across different materials. It is possible to use in a region where the surface is not flat. For example, the micro-Raman spectrometer can also be used on a sample surface having a step pattern such as a shallow trench isolation (STI).

### Optical System of Micro-Raman Spectrometer: Embodiment

FIG. 5 is a configuration diagram of the laser optical system 12 of the micro-Raman spectrometer 10 according to the embodiment. FIG. 5 is an example of the laser optical system 12, which is not limited thereto.

As shown in FIG. 5, the laser light LL emitted from the laser light source 12S is incident on a removal filter (Rejection Filter: RF) via an attenuating filter 13D. The laser light reflected by the removal filter RF is incident on the sample 16 via the lens 80. The light emitted from the sample 16 includes Rayleigh scattered light, the fluorescence FL, and the Raman scattered light RL. Among the light emitted from the sample 16, the Rayleigh scattered light is removed by the removal filter RF. The fluorescence FL is spectrally separated by a fluorescence filter FF1 and input to the fluorescence detector 15F. The Raman scattered light RL is condensed on a slit CF1 via the lens 81. The Raman scattered light RL that has passed through the hole of the slit CF1 is condensed on a slit CF2 via lenses 82 and 83. The Raman scattered light RL that has passed through the hole of the slit CF2 is incident on the Raman scattered light detector 15R. When a fluorescence filter FF2 is used instead of the fluorescence filter FF1, the fluorescence FL and the Raman scattered light RL are condensed on the slit CF1 via the lens 81. The fluorescence FL and the Raman scattered light RL that have passed through the hole of the slit CF1 are input to the fluorescence filter FF2 via the lens 82. The fluorescence FL is spectrally separated by the fluorescence filter FF2 and input to the fluorescence detector 15F. The Raman scattered light RL that is spectrally separated by the fluorescence filter FF2 is condensed on the slit CF2 via the lens 83. The Raman scattered light RL that has passed through the hole of the slit CF2 is incident on the Raman scattered light detector 15R. In FIG. 5, a confocal lens is configured with a combination of the lens 80 and the lens 81, and a combination of the lens 82 and the lens 83.

### Configuration of Sample: FIG. 6A

FIG. 6A is a configuration diagram of the sample 16F in which the fluorescent material 140 is formed on the entire surface. The sample 16F has a combined structure of the carbon region 100 and the silicon region 120, a step is provided in the silicon region 120, and the carbon region 130 is provided on the bottom surface of the step. The fluorescent material 140 to be excited by a wavelength of a Raman measurement laser adheres to the sample surface. The fluorescent material 140 is formed on the surface of the carbon region 100, the surface of the silicon region 120, and the surface of the carbon region 130 in the step portion.

As the material of the fluorescent material 140, nanoparticles or organic molecules may be used. The nanoparticles can be applied and are less likely to fade. In addition, it is also possible to acquire fluorescence from one particle of the nanoparticles. In addition, since the fluorescence wavelength changes depending on the particle size of the nanoparticles, the fluorescence wavelength can be selected by controlling the particle size of the nanoparticles. Depending on the fluorescent material, it is possible to control whether fluorescence is emitted and whether the fluorescence interferes with the Raman scattered light.

Examples of inorganic nanoparticles include ZnSe and InP of semiconductor nanoparticles. Other examples of materials for semiconductor nanoparticles include II-VI compound semiconductors such as CdSe, CdSe/ZnS, or CdTe, Group IV element semiconductors such as silicon or germanium, and Group III-V compound semiconductors such as GaAs.

An example of an organic molecular fluorescent material is chlorophyll. In addition, examples of the fluorescent material include the amino acid residues tryptophan (Trp), phenylalanine (Phe), and tyrosine (Tyr), fluorescent proteins (FP), organic dyes (fluorescein, rhodamine, N-aminocoumarin, and derivatives thereof), fluorescent proteins, and fluorescent organic semiconductors.

### Fluorescence Fading

The organic molecule has an influence on fading, but can be used as fluorescence fading, which is a common method of Raman measurement, by selecting the organic molecular fluorescent material. For example, by adjusting the attenuating filter 13D shown in FIG. 5 and irradiating the organic molecular fluorescent material with strong laser light, the organic molecular fluorescent material can be deteriorated and the fluorescence can be faded, that is, the fluorescence can be eliminated. In the flowchart of FIG. 2, the step of fluorescence fading can be executed after step S3 and immediately before step S4 of the Raman measurement. When measuring the Z position, the intensity of the Raman measurement laser light is set to be low by adjusting the attenuating filter 13D, and when fading the fluorescence, the intensity of the Raman measurement laser light is set to be high by adjusting the attenuating filter 13D. As the light source for fluorescence fading, a light source of Raman measurement laser light may be used, or another light source such as a lamp may be prepared. When fading the fluorescence, the intensity of the Raman measurement laser light is set to be high, but it is necessary to adjust the intensity level so that the surface of the sample 16F is not damaged. In addition, the organic molecular fluorescent material whose fluorescence is faded remains on the surface of the sample 16F, and the Raman measurement is performed in this state.

In the micro-Raman spectrometer according to the embodiment, by controlling the analyzer 21 and the controller 17, it is possible to cause the fluorescent characteristics (i.e., emission intensity, wavelength specificity, quantum yield, and/or fluorescence lifetime) of the fluorescent material to be lost by irradiating the fluorescent material with the laser light of the laser optical system 12 at a first output (e.g., high-intensity laser power level sufficient to degrade and/or alter the fluorescent properties of the material through photobleaching, thermal degradation, and/or photoinduced chemical modification) before performing detection by the Raman scattered light detector. The fluorescent characteristics can be temporarily suppressed, permanently degraded, and/or selectively altered to reduce interference with Raman measurements. Losing fluorescent characteristics can include photobleaching, thermal quenching, molecular dissociation, and/or oxidation-induced fluorescence loss.

The laser optical system 12 has the attenuating filter 13D (see FIG. 5), and when performing detection by the Raman scattered light detector 15R, the attenuating filter 13D attenuates the laser light LL to a second output (e.g., a reduced power level sufficient for Raman signal acquisition without further degrading the sample or inducing fluorescence artifacts) lower than the first output. When irradiating with the laser light LL at the first output, the attenuating filter 13D may not be used or the attenuation amount may be reduced by controlling the attenuating filter 13D. In this case, the fluorescent function of the fluorescent material portion corresponding to the size of the laser spot can be lost. In addition, another laser device than the laser light source 12S of the laser optical system 12 may be prepared.

### Film Thickness of Fluorescent Material

The film thickness of the fluorescent material 140 is important when applied. It is important to be able to measure a sufficient fluorescence intensity from the fluorescent material 140 with the fluorescence detector 15F and to be able to secure the Raman intensity of the sample-derived Raman scattered light RL with the Raman scattered light detector 15R. In the micro-Raman spectrometer 10 according to the embodiment, the fluorescent material 140 adheres to the surface of the sample 16F at an appropriate thickness, and the focus is aligned by detecting the fluorescence intensity. The Raman measurement is executed while the fluorescent material 140 adheres to the surface of the sample 16F. The thickness of the fluorescent material 140 is a thickness that secures a sufficient fluorescence intensity and a sufficient Raman scattering intensity. For example, the thickness of the fluorescent material 140 is about several nm to several tens of nm.

In general, the intensity of the Raman scattered light RL is about 4 to 6 digits lower than the intensity of the fluorescence FL. The intensity of the Raman scattered light RL can be adjusted by the amount of the fluorescent material 140 applied. The film thickness of the fluorescent material 140 applied is preferably thin in a range where a sufficient fluorescence intensity is obtained. For example, if the amount of the fluorescent material 140 applied can be adjusted to secure the SN ratio of the Raman scattered light RL, it is also possible to reduce the intensity of the Raman scattered light RL by about one to two digits compared to the intensity of the fluorescence FL.

In the micro-Raman spectrometer 10 according to the embodiment, when taking a mapping measurement across different materials by using the micro-Raman spectroscopy, the focus of the laser light can be aligned regardless of the material type and the surface shape. The focus alignment of the micro-Raman measurement is performed by intentionally causing the fluorescent material 140, which is supposed to interfere with the acquisition of the Raman scattered light RL by the fluorescence FL, to adhere by the sample pre-processing and using the fluorescence intensity.

According to the micro-Raman spectrometer according to the embodiment, the focus of the sample surface can be aligned by using the fluorescence intensity without using the Raman Rayleigh scattered light, regardless of the shape and material type of the semiconductor device, and thus stable mapping with high spatial resolution can be acquired.

### Hydrophilicity and Hydrophobicity of Nanoparticles

With the micro-Raman spectrometer according to the embodiment, additional spatial information can be acquired by controlling a pre-processing method. With the control of the pre-processing method, it is possible to acquire the surface characteristics other than the optical characteristics such as hydrophilicity and hydrophobicity. The surface characteristics can be acquired together with the XYZ mapping information of the surface. The nanoparticles are spherical particles. The nanoparticles are dispersed in a liquid when the nanoparticles are applied. Therefore, it is necessary to modify the surface of the nanoparticles with molecules. The nanoparticles are dispersed in a liquid by binding a molecular modifying group to a chain of carbon on the surface of the nanoparticles. Here, hydrophilicity or hydrophobicity can be imparted to the nanoparticles by making the modifying group hydrophilic or hydrophobic. By applying the nanoparticles, it is possible to distinguish whether the surface of the sample is hydrophilic or hydrophobic. Since the fluorescence wavelength differs depending on the hydrophilicity or hydrophobicity of the nanoparticles, by monitoring the fluorescence wavelength, it is possible to distinguish whether the surface of a sample is hydrophilic or hydrophobic.

### Configuration of Sample: FIG. 6B

FIG. 6B is a configuration diagram of a sample 16B in which one type of fluorescent material 142 is formed on a part of the surface (e.g., formed on a portion of the surface).

The hydrophilic fluorescent material 142 is obtained by binding a hydrophilic modifying group to a chain of carbon on the surface of the nanoparticles. In FIG. 6B, the hydrophilic fluorescent material 142 is formed on a hydrophilic surface of the surface of the silicon region 120 such as a silicon wafer. On the other hand, the silicon region 120 in which the hydrophilic fluorescent material 142 is not formed has a hydrophobic surface 120S. While FIG. 6A illustrates an example in which the hydrophilic fluorescent material 142 adhere entirely to the surfaces of the carbon region 100, the silicon region 120, and the step carbon region 130, the hydrophilic fluorescent material 142 can adhere selectively to the carbon region 100 and the step carbon region 130 or to the silicon region 120 (without the step carbon region 130). For example, to cause the hydrophilic fluorescent material 142 adhere selectively to the carbon region 100 and the step carbon region 130, the surfaces of the carbon region 100 and the step carbon region 130 may be first chemically processed with a material having a selectivity to the carbon and thereafter chemically modified with the hydrophilic fluorescent material 142.

In the structure of FIG. 6B, the hydrophilic fluorescent material 142 of a nanoparticle film is only applied on a specific Si surface region of the sample 16F, and the other surface region has the hydrophobic surface 120S. In this case, fluorescence is observed from the region having the fluorescent material 142, and fluorescence is not observed from the region having the other hydrophobic surface 120S.

The fluorescent material 142 is applied to the hydrophilic region, which is a part of the surface of the sample 16B (e.g., applied to a portion of the surface), and the controller 17 first detects the XY position of the hydrophilic region, and then adjusts (e.g., updates) the Z position based on the detection result of the fluorescence detector. That is, the controller can detect the XY position of the hydrophilic region, and responsive to detecting the XY position of the hydrophilic region, update the Z position.

A micro-Raman measurement method using the sample 16B on a surface of which the hydrophilic fluorescent material 142 is formed will be described below.
(A) First, in step S1, the hydrophilic fluorescent material 142 to be excited by the wavelength of the Raman measurement laser light adheres to the surface of the sample 16B.
(B) Next, in step S2, the surface of the sample 16B is irradiated with the Raman measurement laser light, and the fluorescence intensity from the fluorescent material 142 is detected by the fluorescence detector 15F. By monitoring the fluorescence intensity from the fluorescent material 142, the optimum Z position can be measured. In step S2, information on the surface shape of the sample, which is stored in advance in the third memory MR3 (XYZ information and information on the hydrophilic and hydrophobic surfaces), may be referred to. In addition, prior information such as design information and layout information of the sample may be referred to. As a result, an initial value on the XY plane can be efficiently set.
(C) Next, in step S3, a wavelength of the Raman measurement laser light is selected. As described above, step S3 may be omitted when there is no need to change the Raman excitation wavelength.
(D) Next, in step S4, the surface of the sample 16B is irradiated with the Raman measurement laser light, and the Raman scattering intensity is detected by the Raman scattered light detector 15R. The following steps are the same as in FIG. 2.

### Configuration of Sample: FIG. 6C

FIG. 6C is a configuration diagram of the sample 16C on a surface of which two types of fluorescent materials are formed.

By binding a hydrophilic modifying group to a chain of carbon on the surface of the nanoparticles, the hydrophilic fluorescent material 142 is obtained, and on the other hand, by binding a hydrophobic modifying group to a chain of carbon on the surface of the nanoparticles, a hydrophobic fluorescent material 146 is obtained. In FIG. 6C, the hydrophilic fluorescent material 142 is formed on a hydrophilic surface portion on the surface of the silicon region 120, such as a surface of a silicon wafer, and the hydrophobic fluorescent material 146 is formed on a surface portion of the silicon region 120 having hydrophobicity.

A micro-Raman measurement method using the sample 16C on a surface of which two types of the hydrophilic fluorescent material 142 and the hydrophobic fluorescent material 146 are formed will be described below.
(A) First, in step S1, the hydrophilic fluorescent material 142 and the hydrophobic fluorescent material 146 that are to be excited by the wavelength of the Raman measurement laser light adhere to the surface of the sample 16C.
(B) Next, in step S2, the surface of the sample 16C is irradiated with the Raman measurement laser light, and the fluorescence intensity from the fluorescent material 142 and the fluorescent material 146 is detected by the fluorescence detector 15F. By monitoring the fluorescence intensity from the fluorescent material 142 and the fluorescent material 146, the optimum Z position can be measured. In addition, since the fluorescence wavelengths from the fluorescent material 142 and the fluorescent material 146 are different from each other, the information on the surface having hydrophilicity and hydrophobicity can be acquired by analyzing the wavelengths. In step S2, the information on the surface shape of the sample (XYZ information, information on the hydrophilic and hydrophobic surfaces) that is stored in advance in the third memory MR3 may be referred to. In addition, prior information such as design information and layout information of the sample may be referred to. As a result, an initial value on the XY plane can be efficiently set.
(C) Next, in step S3, a wavelength of the Raman measurement laser light is selected. As described above, step S3 may be omitted when there is no need to change the Raman excitation wavelength.
(D) Next, in step S4, the Raman measurement laser light is incident on the surface of the sample 16C, and the Raman scattering intensity is detected by the Raman scattered light detector 15R. The following steps are the same as in FIG. 2.

As the fluorescent material, a first fluorescent material is applied to a first portion (hydrophilic region, a first part) on the surface of the sample (e.g., first fluorescent material can be applied on a portion of a surface, the surface can be coated, in part, with a first fluorescent material), and a second fluorescent material is applied to a second portion (hydrophobic region, a second part) on the surface of the sample (e.g., second fluorescent material can be applied on a portion of a surface, the surface can be coated, in part, with a second fluorescent material). The analyzer 21 and the controller 17 first determine whether the first fluorescent material or the second fluorescent material is applied (determine whether the surface is the hydrophilic region or the hydrophobic region), and then perform Z adjustment. When two types of fluorescent materials are used, the measurement accuracy when measuring the XYZ location information is higher than when one type of fluorescent material is used. In addition, a fluorescent material may be formed by using a plurality of types of nanoparticles, not limited to hydrophobicity and hydrophilicity. By using a fluorescent material using a plurality of types of nanoparticles, it is possible to acquire detected wavelength information and surface information of each of the plurality of types of nanoparticles, which reflect the characteristics specific to the plurality of types of nanoparticles.

### ZnSe Nanoparticle Fluorescent Material

An example of using ZnSe nanoparticles as the fluorescent material 140 will be described below. By adjusting the spherical size of ZnSe nanoparticles, the emission wavelength of a fluorescence spectrum FSS can be adjusted. The peak emission wavelength of the fluorescence spectrum FSS can be adjusted in a range of, for example, about 525 nm to 800 nm. The peak intensity and the range of spread wavelength of the fluorescence spectrum FSS depend on the Raman excitation wavelength. By adjusting the Raman excitation wavelength, an excitation intensity can also be adjusted from 100% to 0% depending on the absorption spectrum FAS of the fluorescent material of the ZnSe nanoparticle fluorescent material. For example, the absorption spectrum FAS has a characteristic in which the excitation intensity is gradually attenuated from 100% to 0% as the Raman excitation wavelength increases. More specifically, in the examples of FIGS. 7A and 7B, the excitation intensity is 100% when the Raman excitation wavelength is about 300 nm, and the excitation intensity is 0% when the Raman excitation wavelength is about 950 nm.

FIG. 7A is an explanatory view of the absorption spectrum and the fluorescence spectrum of the fluorescent material of the ZnSe nanoparticle fluorescent material, the Raman excitation wavelength, and the wavelength characteristic of the Raman shift. As the ZnSe nanoparticles, a fluorescent material having a peak emission wavelength of 545 nm of the fluorescence spectrum FSS was used. The Raman excitation wavelength is 355 nm, for example. At the Raman excitation wavelength of 355 nm, the peak of the fluorescence spectrum FSS shows a value of about 40%. When the Raman excitation wavelength is 355 nm, a Raman shift ΔR1 is in the wavenumber range of 2000 cm⁻¹ in Raman measurements of semiconductor materials, and is in the wavenumber range of 3200 cm⁻¹ in general Raman measurements. In the wavenumber range of 3200 cm⁻¹, the Raman shift ΔR1 is in the wavelength range of 355 nm to about 400 nm. This wavelength range is sufficiently separated from the fluorescence spectrum FSS, and it is found that the Raman spectrum target range is not affected by the wavelength range including the tail portion of the fluorescence spectrum FSS.

FIG. 7B is an explanatory view of another example of the absorption and the fluorescence spectrum of the fluorescent material the ZnSe nanoparticle fluorescent material, the Raman excitation wavelength, and the wavelength characteristic of the Raman shift. The Raman excitation wavelength is 485 nm, for example. The same fluorescent material having a peak emission wavelength of 545 nm in the fluorescence spectrum FSS was used as the ZnSe nanoparticles. In normal Raman measurements, a Raman shift ΔR2 is in the wavenumber range of 3200 cm⁻¹, and when the Raman excitation wavelength is 485 nm, the Raman shift ΔR2 is in the wavelength range of 485 nm to about 570 nm. The wavelength range includes the fluorescence spectrum FSS. At a Raman excitation wavelength of 485 nm, the peak of the fluorescence spectrum FSS is 10% or less, but there is a fluorescence peak in the Raman spectrum target range, and there is a possibility of interference even if the fluorescence peak is removed by the fluorescence filter.

The Raman excitation wavelengths of 355 nm and 485 nm both enter the absorption spectrum FAS, and both wavelengths can generate the fluorescence spectrum FSS. At a Raman excitation wavelength of 355 nm, the Raman spectrum target range and the fluorescence peak are sufficiently separated, whereas at a Raman excitation wavelength of 485 nm, the Raman spectrum target range includes the fluorescence spectrum FSS, and thus there is a possibility that the fluorescence spectrum will be superimposed on the Raman spectrum. In this case, the problem can be avoided by using nanoparticles having different particle sizes that generate different fluorescence peaks. For example, by using a fluorescent material having a peak emission wavelength of 705 nm or the like in the fluorescence spectrum FSS, it is possible to avoid the possibility that fluorescence is superimposed on the Raman spectrum target range.

The micro-Raman spectrometer 10 according to the embodiment has hardware for removing or sensing specific fluorescence within the spectrometer, and a software mechanism that reflects the specific fluorescence at the Z position and holds the reflected specific fluorescence as sample surface shape information. The hardware for removing or sensing specific fluorescence is the fluorescence detector 15F and the fluorescence filter FF. The software mechanism that reflects the specific fluorescence at the Z position and holds the reflected specific fluorescence as the sample surface shape information is a program for controlling the controller 17.

The program (e.g., instructions stored on a non-transitory computer-readable storage media that, when executed by at least one processor, cause the at least one processor to perform operations) for operating the micro-Raman spectrometer according to the embodiment includes holding the sample 16F, on a surface of which the fluorescent material 140 to be excited by a wavelength of Raman measurement laser light is applied, on the stage 11 (e.g., holding a sample on a stage, where a fluorescent material applied to a surface of the sample is excitable by a wavelength of the Raman measurement laser light), irradiating the surface of the sample 16F with the Raman measurement laser light to detect an intensity of the fluorescence FL from the fluorescent material 140 by the fluorescence detector 15F, measuring an optimum Z position for irradiating the XY plane of the sample 16F with the laser light in the Z direction perpendicular to the XY plane at a certain XY position (e.g., a predefined grid location, dynamically determined measurement point, and/or adaptive scanning coordinate based on fluorescence intensity variations) on the XY plane based on information on the surface shape of the sample stored in advance in the third memory MR3 by the controller 17 based on a detection result (e.g., peak fluorescence intensity, spatial fluorescence distribution, and/or time-resolved fluorescence decay) of the fluorescence detector 15F, causing selected Raman measurement laser light to be incident on the surface of the sample 16F to detect an intensity of Raman scattered light RL by the Raman scattered light detector 15R, analyzing a component of an analysis target film by comparing a plurality of types of component distributions with a reference spectrum saved in the first memory MR1 by the analyzer 21 and saving an analysis result in the second memory MR2, next, moving the stage 11 in the XY direction to measure the optimum Z position at a different XY position and saving another analysis (e.g., second analysis) result by the analyzer 21 in the second memory MR2, and acquiring information on the surface shape of the sample 16F, and storing the acquired information on the surface shape of the sample 16F in the third memory MR3. This program is an example of a program for operating the micro-Raman spectrometer according to the embodiment.

The procedure of the micro-Raman measurement method according to the embodiment may be incorporated into a program and read and executed by a computer. As a result, each series of procedures of the micro-Raman measurement method can be implemented by using a general-purpose computer connected to the micro-Raman spectrometer according to the embodiment. In addition, a program may be stored in a non-transitory recording medium, such as a flexible disk, CD-ROM, as a non-transitory computer-readable medium containing the program for causing a computer to execute a series of procedures, and may be read and executed by the computer.

The recording medium is not limited to a portable medium such as a magnetic disk or an optical disk but may be a fixed recording medium such as a hard disk device or a memory. In addition, a program in which the above-described series of procedures are incorporated may be distributed via a communication line such as the Internet (including wireless communication). Further, the program in which the series of procedures described above are incorporated may be encrypted, modulated, or compressed, and may be distributed via a wired line or a wireless line such as the Internet, or may be stored in a non-temporary recording medium.

### Effect of Embodiment

According to one embodiment, a micro-Raman spectrometer, a micro-Raman measurement method, and a program can be provided, in which high spatial resolution is stably obtained even when performing mapping measurement across materials having different compositions and physical properties in micro-Raman spectroscopy.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A micro-Raman spectrometer, comprising:
a stage configured to hold a sample comprising a fluorescent material applied on a surface;
a laser optical system configured to irradiate the sample with laser light;
a Raman scattered light detector configured to detect Raman scattered light emitted from the sample;
a fluorescence detector configured to detect fluorescence emitted from the fluorescent material;
an analyzer configured to analyze a Raman signal of the Raman scattered light detector and a fluorescence signal of the fluorescence detector; and
a controller connected to the analyzer and configured to control the stage and the laser optical system, wherein the controller updates a Z position for irradiating an XY plane of the sample with the laser light in a Z direction perpendicular to the XY plane at a XY position on the XY plane based on a detection result of the fluorescence detector, and performs detection by the Raman scattered light detector at the Z position.

2. The micro-Raman spectrometer of claim 1, further comprising:
a third memory connected to the controller, wherein the third memory stores combination information of the XY position and the Z position.

3. The micro-Raman spectrometer of claim 1, wherein the controller irradiates the sample with the laser light at a first output after adjusting the Z position and before performing the detection by the Raman scattered light detector, to cause fluorescent characteristics of the fluorescent material to be lost.

4. The micro-Raman spectrometer of claim 3, wherein the laser optical system comprises an attenuating filter, and wherein when the detection is performed by the Raman scattered light detector, the laser light is attenuated to a second output lower than the first output by the attenuating filter.

5. The micro-Raman spectrometer of claim 1, wherein the fluorescent material is an organic fluorescent material, and wherein the micro-Raman spectrometer further comprises an ashing mechanism configured to remove the organic fluorescent material.

6. The micro-Raman spectrometer of claim 1, wherein:
the fluorescent material is applied to a hydrophilic region of the surface of the sample; and
the controller detects an XY position of the hydrophilic region, and updates the Z position based on the detection result of the fluorescence detector.

7. The micro-Raman spectrometer of claim 1, wherein:
the fluorescent material comprises a first fluorescent material and a second fluorescent material;
the first fluorescent material is applied to a hydrophilic region corresponding to a first part of the surface of the sample; and
the second fluorescent material is applied to a hydrophobic region corresponding to a second part of the surface of the sample.

8. The micro-Raman spectrometer of claim 7, wherein the controller determines whether the surface is the hydrophilic region or the hydrophobic region by determining whether the fluorescent material is the first fluorescent material or the second fluorescent material, and updates the Z position based on the detection result of the fluorescence detector.

9. A micro-Raman measurement method, comprising:
holding a sample on a stage, wherein a fluorescent material applied to a surface of the sample is excitable by a wavelength of Raman measurement laser light;
irradiating the surface of the sample with the Raman measurement laser light to detect an intensity of fluorescence from the fluorescent material by a fluorescence detector;
measuring a Z position for irradiating an XY plane of the sample with the Raman measurement laser light in a Z direction perpendicular to the XY plane at a XY position on the XY plane by a controller based on a detection result of the fluorescence detector;
causing selected Raman measurement laser light to be incident on the surface of the sample to detect an intensity of Raman scattered light by a Raman scattered light detector;
analyzing a component of an analysis target film by comparing a plurality of types of component distributions with a reference spectrum saved in a first memory by an analyzer and saving an analysis result in a second memory;
moving the stage in an XY direction to measure a Z position at a different XY position and saving a second analysis result by the analyzer in the second memory, and acquiring information on a surface shape of the sample; and
storing the acquired information on the surface shape of the sample in a third memory.

10. The micro-Raman measurement method of claim 9, wherein the controller irradiates the sample with the Raman measurement laser light at a first output after adjusting the Z position and before performing the detection by the Raman scattered light detector, to cause fluorescent characteristics of the fluorescent material to be lost.

11. The micro-Raman measurement method of claim 10, wherein when the detection is performed by the Raman scattered light detector, the Raman measurement laser light is attenuated to a second output lower than the first output by an attenuating filter.

12. The micro-Raman measurement method of claim 9, wherein the fluorescent material is an organic fluorescent material.

13. The micro-Raman measurement method of claim 9, wherein:
the fluorescent material is applied to a hydrophilic region of the surface of the sample; and
the method further comprising:
detecting an XY position of the hydrophilic region, and updating the Z position based on the detection result of the fluorescence detector.

14. The micro-Raman measurement method of claim 9, wherein:
the fluorescent material comprises a first fluorescent material and a second fluorescent material;
the first fluorescent material is applied to a hydrophilic region corresponding to a first part of the surface of the sample; and
the second fluorescent material is applied to a hydrophobic region corresponding to a second part of the surface of the sample.

15. The micro-Raman measurement method of claim 14, wherein the method further comprising:
determines whether the surface is the hydrophilic region or the hydrophobic region by determining whether the fluorescent material is the first fluorescent material or the second fluorescent material;
updating the Z position based on the detection result of the fluorescence detector.

16. A non-transitory computer-readable storage media having instructions stored thereon that, when executed by at least one processor, cause the at least one processor to perform operations comprising:
holding a sample on a stage, wherein a fluorescent material applied to a surface of the sample is excitable by a wavelength of Raman measurement laser light;
irradiating the surface of the sample with the Raman measurement laser light to detect an intensity of fluorescence from the fluorescent material by a fluorescence detector;
measuring a Z position for irradiating an XY plane of the sample with the Raman measurement laser light in a Z direction perpendicular to the XY plane at a XY position on the XY plane by a controller based on a detection result of the fluorescence detector;
causing selected Raman measurement laser light to be incident on the surface of the sample to detect an intensity of Raman scattered light by a Raman scattered light detector;
analyzing a component of an analysis target film by comparing a plurality of types of component distributions with a reference spectrum saved in a first memory by an analyzer and saving an analysis result in a second memory;
moving the stage in an XY direction to measure a Z position at a different XY position and saving a second analysis result by the analyzer in the second memory, and acquiring information on a surface shape of the sample; and
storing the acquired information on the surface shape of the sample in a third memory.
